(19) United States
(12) Patent Application Publication
(10) Pub. No.: US 2014/0019825 A1
(43) Pub. Date: Jan. 16, 2014

(54) ACCELERATING ERROR-CORRECTION DECODER SIMULATIONS WITH THE ADDITION OF ARBITRARY NOISE

(71) Applicant: LSI CORPORATION, San Jose, CA (US)

(72) Inventors: Pavel Aleksandrovich Aliseychik, Moscow (RU); Dmitry N. Babin, Moscow (RU); Alexander Nikolaevich Filippov, Moscow (RU); Aleksey Alexandrovich Letunovskiy, Moscow (RU); Denis Vladimirovich Parkhomenko, Moscow (RU)

(73) Assignee: LSI Corporation, San Jose, CA (US)

(21) Appl. No.: 13/771,384

(22) Filed: Feb. 20, 2013

(30) Foreign Application Priority Data
Jul. 13, 2012 (RU) 2012129926

(51) Int. Cl. G06F 11/10

(52) U.S. Cl. CPC G06F 11/10
USPC 714/763

(57) ABSTRACT

In one embodiment, a simulator, e.g., for a hard-disk drive selects for testing a signal-to-noise ratio (SNR) value from a range of ratios and an error-correction codeword pattern from a range of codeword patterns. The simulator simulates a communications channel by applying write noise, inter-symbol interference, and read noise to the codeword pattern to generate a noisy signal. In addition, the simulator adds arbitrary-noise to the codeword to accelerate the speed of the simulation. The arbitrary noise increases the probability of converging on a trapping set and does not represent any noise introduced by the communications channel. The simulator attempts to decode the noisy signal, and if decoding is unsuccessful, then the simulator increments an error counter corresponding to the selected signal-to-noise ratio. This process is repeated for all possible combinations of signal-to-noise ratio values and codeword patterns to determine the error rate for all of the signal-to-noise ratio values.

### SUMMARY

One embodiment is a processor-implemented method for simulating performance of an error-correction decoder. The method comprises steps (a)-(d). Step (a) comprises generating an error-correction encoded codeword. Step (b) comprises generating an arbitrary-noise signal. Step (c) comprises modifying the error-correction encoded codeword based on simulated characteristics of a communications channel and the arbitrary-noise signal to generate a noisy error-correction encoded codeword. Step (d) comprises simulating decoding of the noisy error-correction encoded codeword to attempt to recover the error-correction encoded codeword.

Another embodiment is a communications simulator adapted to implement the method described above. The communications simulator comprises a codeword generator adapted to implement step (a), an arbitrary-noise generator adapted to implement step (b), a channel simulator adapted to implement step (c), and an error-correction decoder simulator adapted to implement step (d).

Yet another embodiment is a non-transitory computer-readable storage medium comprising instructions for simulating performance of an error-correction decoder, wherein, when the instructions are executed by a machine, machine performs steps (a)-(d) above.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 shows a simplified block diagram of a communications simulator according to one embodiment of the disclosure;

FIG. 2 shows a simplified flow diagram of a simulation performed by the communications simulator of FIG. 1 according to an embodiment of the disclosure;

FIG. 3 shows a simplified flow diagram of a simulation performed by the communications simulator of FIG. 1 according to another embodiment of the disclosure;

FIG. 4 graphically illustrates the effect that the addition of arbitrary noise has on the simulations performed by the communications simulator of FIG. 1; and

FIG. 5 shows a simplified flow diagram of a method for selecting a receiver configuration according to one embodiment of the disclosure.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

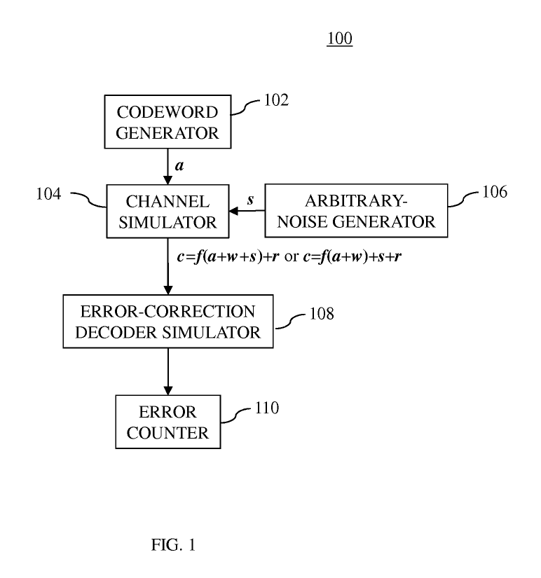

FIG. 1 shows a simplified block diagram of a communications simulator 100 according to one embodiment of the disclosure. Communications simulator 100 comprises a codeword generator 102, a channel simulator 104, an arbitrary-noise generator 106, an error-correction decoder simulator 108, and an error counter 110. Each of these blocks is implemented as a processing block in a software program implemented in communications simulator 100, where communications simulator 100 may be, for example, a digital signal processor, micro-controller, or general-purpose computer.

Codeword generator 102 generates error-correction codeword patterns a according to a specified error-correction encoding scheme, such as a specified low-density parity-check (LDPC) matrix, where each codeword pattern a is a sequence of values, such as bits. Each codeword pattern a is provided to channel simulator 104, which simulates the properties of a communications channel. In a storage device, the communications channel may comprise part of the write path (i.e., the transmitter) of the data storage device, the storage medium, and part of the read path (i.e., the receiver) of the data storage device. The write path contributes to channel noise as part of process of converting the digital codeword to analog format and transmitting the analog codeword to the channel. The read path contributes to the channel noise as part of the process of retrieving the analog codeword from the storage medium and converting the analog codeword to digital format. The storage medium may be, for example, a hard-disk drive, flash memory, a solid-state drive, etc. Note that, as used herein, the term “transmitter” refers to devices that transmit signals via wireless or wired connections as well as write paths of storage devices that transmit data to the storage mediums. Further, as used herein, the term “receiver” refers to devices that receive signals from transmitters via wireless or wired connections as well as devices such as read channels of storage devices that recover data from storage mediums.

For each codeword a, channel simulator 104 applies to the codeword a (i) a write-noise vector w, (ii) inter-symbol interference (ISI), and (iii) a read-noise vector r. The write-noise vector w simulates the noise that is introduced to the codeword a when the codeword a is written to an actual storage medium. The write noise is typically a combination of jitter and additive (e.g., electrical) noises. Inter-symbol interference, which is represented by the function “ƒ” in FIG. 1, is the interference that occurs between bits of the codeword a when the codeword a is written and read from the actual storage medium. Inter-symbol interference is typically a function of the density in which the bits of data are stored on the storage medium. A common model of the inter-symbol interference is a linear filter applied to the signal. The read-noise vector r simulates the noise that is introduced to the codeword a when the codeword a is read from the actual storage medium. Like the write noise, read noise is typically a combination of jitter and additive (e.g., electrical) noises. According to at least some embodiments of the disclosure, vectors a, w, and r all have the same length.

In addition to write noise, inter-symbol interference, and read noise, channel simulator 104 applies an arbitrary-noise vector s to the codeword a. The arbitrary-noise vector s, which is generated by arbitrary-noise generator 106, does not represent any noise introduced by the communications channel. Rather, arbitrary-noise vector s is merely arbitrary noise that is added to each codeword a before simulating decoding to accelerate the speed of the simulation as described in further detail below. The arbitrary-noise vector s, which has the same length as codeword a according to at least some embodiments of the disclosure, is added before or after applying inter-symbol interference to generate a noisy signal c. In a hard-disk drive, the noisy signal c corresponds to a sector of data written to, stored on, and then read from the platter of the hard-disk drive.

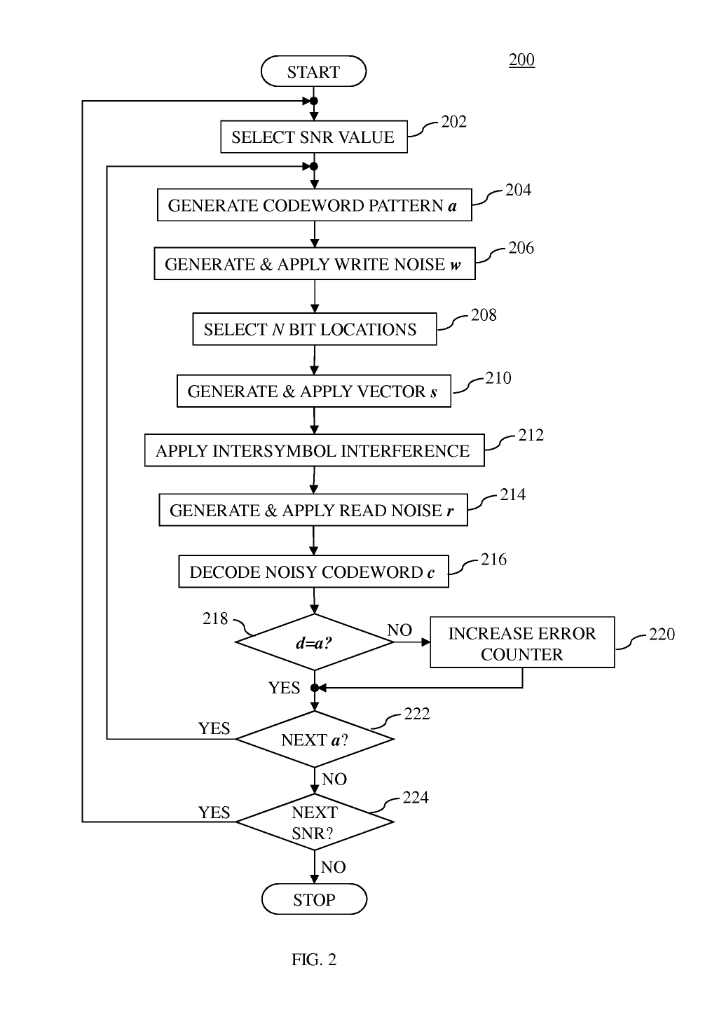

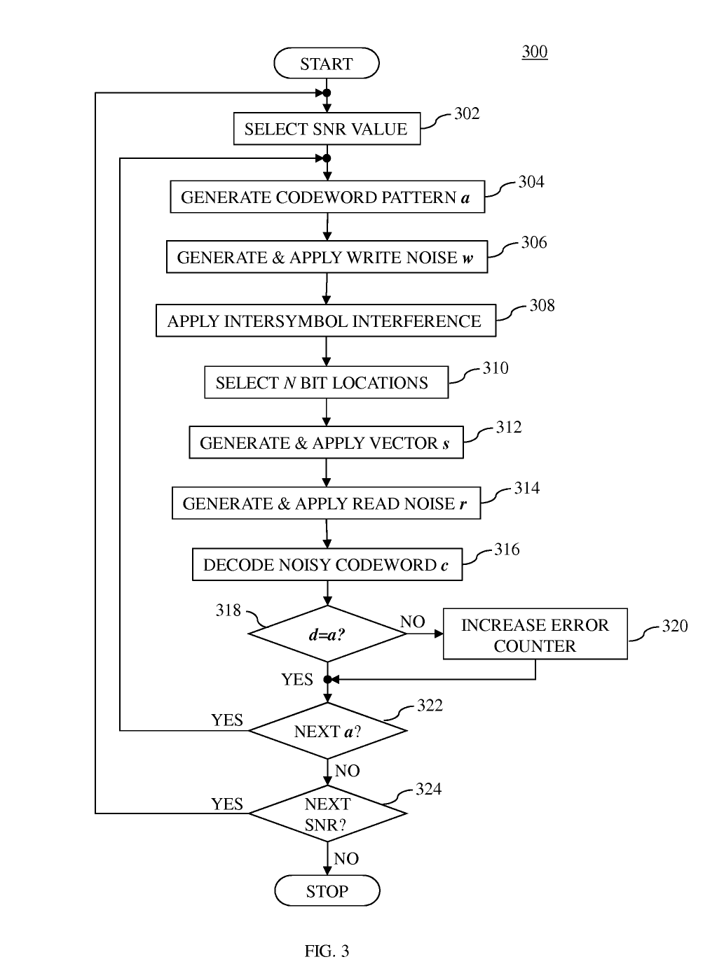

The noisy signal c is provided to error-correction decoder simulator 108, which simulates the behavior of an error-correction decoder. Error-correction decoder simulator 108 decodes the noisy signal c to obtain a decoded codeword d. If the decoded codeword d=a, then decoding is successful. Otherwise, decoding is unsuccessful, and communications simulator 100 increments an error counter 110 by a value of one as described in further detail below. To further understand the operations of communications simulator 100, consider FIGS. 2 and 3.

FIG. 2 shows a simplified flow diagram of a simulation method 200 performed by communications simulator 100 of FIG. 1 according to an embodiment of the disclosure. In this embodiment, simulator 100 adds an arbitrary-noise vector s to each codeword before applying inter-symbol interference to the codeword. In general, communications simulator 100 initially selects a signal-to-noise ratio (SNR) value (step 202) from a range of signal-to-noise ratio values. The range of signal-to-noise ratio values is selected based on the performance characteristics of the communications channel being simulated. Further, the noise portion of the signal-to-noise ratio value corresponds to the total noise level that may be introduced by the communications channel being simulated, where the total noise level is a sum of the write noise, the read noise, and the arbitrary noise.

Upon selecting the initial signal-to-noise ratio value, codeword generator 102 of simulator 100 generates an initial codeword pattern α (step 204), and communications simulator 100 tests the ability of a simulated receiver to decode the initial codeword pattern a at the selected signal-to-noise ratio value (steps 206-220, described further below) when arbitrary noise is added. The simulated receiver comprises a read channel, which is part of the read path of the storage device and comprises one or more channel detectors and one or more interleavers/de-interleavers, and error-correction decoder 108.

If, after testing the initial codeword pattern α, there is another codeword pattern a to test for the currently selected signal-to-noise ratio value (step 222), then communications simulator 100 repeats steps 204-220 for the next codeword pattern a at the selected signal-to-noise ratio value. The number of codeword patterns a tested may be specified to be equal to the total number of possible codewords a that may be generated for the selected error-correction code or a subset of the possible codewords a.

If, after testing all of the specified codeword patterns a at the initial signal-to-noise ratio value, another signal-to-noise ratio value is to be considered (step 224), then communications simulator 100 selects the next signal-to-noise ratio value (step 202) and repeats steps 204 to 224 for the next signal-to-noise ratio value. The number of signal-to-noise ratio values tested may be specified to be equal to, for example, the number of signal-to-noise ratio values in the range of signal-to-noise ratio values or a subset of the number of signal-to-noise ratio values in the range.

Regarding steps 206-220, for each combination of a signal-to-noise ratio value (step 202) and a codeword pattern a (step 204), channel simulator 104 of communications simulator 100 generates and adds a write-noise vector w to the codeword pattern α to generate a write-noise adjusted codeword a+w (e.g., step 206). The write-noise vector w is generated to be a portion of the total overall noise that makes up the selected signal-to-noise ratio value. After applying the write-noise vector w, arbitrary-noise generator 106 of communications simulator 100 selects N specific bit locations (step 208) at which the arbitrary noise will be added. In at least some embodiments of the disclosure, the number N is constant for the entire simulation (i.e., the testing of all combinations of signal-to-noise ratio values and codeword patterns a). As an example, if the codeword length is 5,000 bits, then N may be selected to be 30 bits.

The particular N locations that are adjusted may be selected using any of a number of different techniques. For example, the N locations may be selected randomly, making sure that all N locations are different. As another example, the N locations may be selected from a subset of locations, where the subset of locations comprises those locations in which added noise is likely to have a relatively significant impact. For instance, for channels having inter-symbol interference and jitter, the location i is likely to have a relatively significant impact if aᵢ₋₁≠aᵢ≠aᵢ₊₁, where aᵢ is the i^{th} value in the codeword pattern a, because there is a relatively high probability that jitter noise is high in such location. Other ways of selecting the N arbitrary noise locations can be also used. In at least some embodiments of the disclosure, these locations do not depend on the LDPC matrix. Further, in at least some embodiments of the disclosure, these locations are not fixed and may vary from one combination of a signal-to-noise ratio value and a codeword pattern a to the next.

After selecting the N locations, arbitrary-noise generator 106 of communications simulator 100 generates an arbitrary-noise vector s, and channel simulator 104 applies the arbitrary-noise vector s to the write-noise adjusted codeword a+w to generate an arbitrary-noise adjusted codeword a+w+s (step 210). Arbitrary-noise generator 106 generates each value s, of the arbitrary-noise vector s, where sᵢ is the i^{th} value of the arbitrary-noise vector s, such that (i) each value sᵢ≠0 at the N selected locations and (ii) each value sᵢ=0 everywhere else. The values sᵢ at the N selected locations may be generated using any of a number of different techniques.

For example, each value sᵢ of the arbitrary-noise vector s at the N locations may be set equal to M×wᵢ, where wᵢ is the i^{th} value of the write-noise vector w and M is a generation parameter, M>1 (e.g., 10), that is constant for the entire simulation (i.e., the testing of all combinations of signal-to-noise ratio values and codeword patterns a), and “×” represents scalar multiplication. As another example, each value sᵢ may be set equal to (−aᵢ)×M×wᵢ, where aᵢ is a bit in the codeword pattern a, to ensure that adding sᵢ increases the probability of a decoding error. As yet another example, each value sᵢ may be set equal to (−aᵢ)×M×α, where a is a fixed or random noise value that is generated based on the signal-to-noise ratio value. For instance, α can be an average value of wᵢ to ensure that each value sᵢ≠0. Other ways of generating the arbitrary noise values sᵢ at the N locations can also be used.

After adding the arbitrary-noise vector s, channel simulator 104 (i) applies inter-symbol interference to the arbitrary-noise adjusted codeword a+w+s to generate an inter-symbol-interference-adjusted codeword b, where b=f(a+w+s) (step 212), and (ii) generates and applies a read-noise vector r to the inter-symbol-intereference-adjusted codeword b to generate a noisy signal c, where c=b+r=f(a+w+s)+r (step 214). The read-noise vector r is generated to be a portion of the total overall noise that makes up the selected signal-to-noise ratio value.

Error-correction decoder simulator 108 attempts to decode the noisy signal c (step 216). If, upon decoding the noisy signal c, the decoded codeword d matches the codeword pattern a (i.e., d=a) (step 218), then decoding of the noisy signal c is successful. If, on the other hand, the decoded codeword d does not match the codeword pattern a (i.e., d≠a) (step 218), then decoding of the noisy signal c is unsuccessful. In such case, an error counter 110 corresponding to the selected signal-to-noise ratio value is increased by a value of one (step 220). Upon the successful or unsuccessful decoding of the noisy signal c, processing returns to step 204 for the next codeword pattern a if there is another codeword pattern a to test (step 222). If there is not another codeword pattern a to process, then processing returns to step 202 to test another signal-to-noise ratio value if there is another signal-to-noise ratio value to test (step 224). If there is not another signal-to-noise ratio value to test, then processing stops.

FIG. 3 shows a simplified flow diagram of a simulation method 300 performed by communications simulator 100 of FIG. 1 according to another embodiment of the disclosure. Unlike the embodiment of FIG. 2 where the arbitrary-noise vector s is added to each codeword before applying inter-symbol interference, in this embodiment, communications simulator 100 adds an arbitrary-noise vector s to each codeword after applying inter-symbol interference to the codeword.

In particular, steps 302-306 and 314-324 of FIG. 3 are identical to steps 202-206 and 214-224, respectively, of FIG. 2. The only differences are in steps 308-312, where the inter-symbol interference is applied (step 308) before the N bit locations are selected (step 310) and the arbitrary-noise vector s is applied.

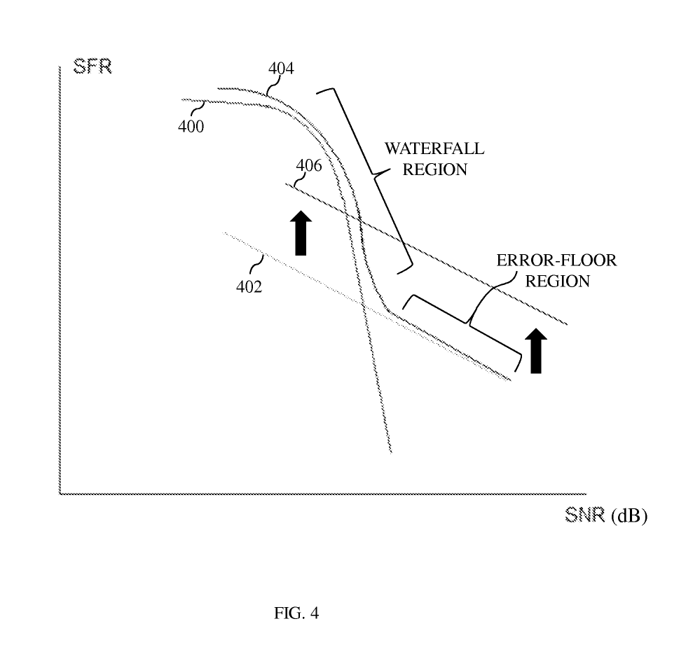

FIG. 4 graphically illustrates the effect that the addition of arbitrary noise can have on simulations performed by communications simulator 100 of FIG. 1. In this graph, the signal-to-noise ratio (SNR) values in decibels (dB) are plotted on the horizontal axis, and the sector failure rates (SFR) are plotted on the vertical axis, where the sector failure rates are represented as logarithmic values. In general, there are two things that contribute to the failure rate of an error-correction decoder: the channel noise level and trapping sets. Trapping sets represent relatively isolated subgraphs in a Tanner graph of an error-correction code. Trapping sets are caused by the passing of incorrect information between the check nodes and variable nodes that force the error-correction decoder to converge to an incorrect result. Each variable node corresponds to a different column of the error-correction code's parity-check matrix (i.e., a different bit of the codeword), and each check node corresponds to a different row of the parity-check matrix.

The contribution of the channel noise level to the sector failure rate when arbitrary noise is not added is illustrated by curve 400, and the contribution of trapping sets to the sector failure rate when arbitrary noise is not added is illustrated by curve 402. Curve 404 is the sum of curves 400 and 402 and represents the total sector failure rate when arbitrary noise is not added. As illustrated by curves 400-404, the sector total failure rate of the error-correction decoder is determined in large part by the noise level when the noise level is relatively high (i.e., the signal-to-noise ratio is relatively low). However, as the noise level decreases (i.e., the signal-to-noise ratio increases), the contribution of the noise level to the total sector failure rate decreases relatively rapidly until the noise level has little to no contribution to the total sector failure rate. At relatively low noise levels, on the other hand, the total sector failure rate of the error-correction decoder is determined in large part by trapping sets. The contribution of the noise level and trapping sets on the sector failure rate results in curve 404 being defined by two distinct regions: an initial “waterfall” region where the sector failure rate improves (decreases) rapidly given a unit increase in signal-to-noise ratio, and a subsequent “error-floor” region where increases in signal-to-noise ratio yield only modest improvements in the sector failure rate.

If communications simulator 100 does not add arbitrary noise to the simulations, then the error-floor region could begin at a sector failure rate of about 10⁻⁶ or possibly even lower. Obtaining reliable simulation results (i.e., sufficient error hits) at such low error rates can take weeks, months, or even years. However, communications simulator 100 increases the error-floor as illustrated by curve 406 by adding arbitrary noise to the simulations. Adding arbitrary noise increases the probability that trapping sets will be encountered. Thus, by adding arbitrary noise to the simulations, the simulations can be accelerated such that simulation results are obtained in a shorter period of time. For example, the sector failure rate at the error floor can be increased from 10⁻⁶ to 10⁻³ by adding arbitrary noise, such that simulation results are obtained about 1,000 times faster than when arbitrary noise is not added. In at least some embodiments of the disclosure, the number N of bit locations and the amount of noise added at each bit location (e.g., the value of generation parameter M) are selected to balance the acceleration rate with the accuracy of the simulation. In at least some cases, using too high of an acceleration rate can result in inaccurate simulation results.

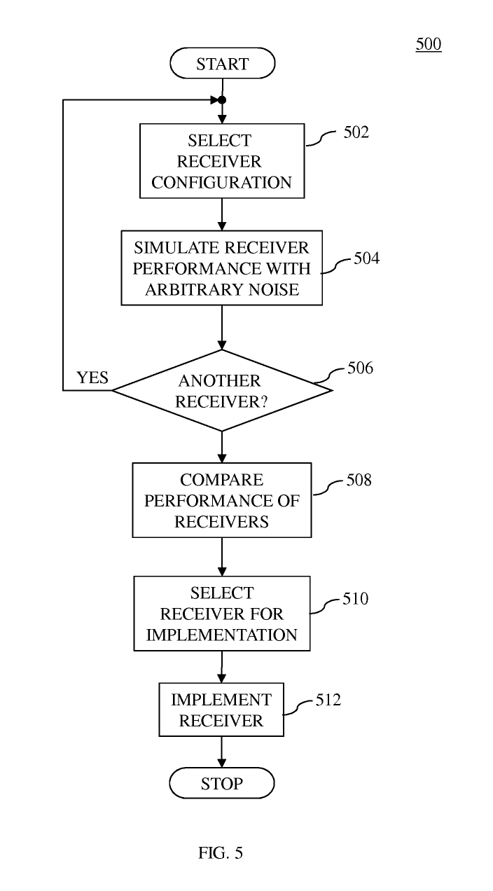

FIG. 5 shows a simplified flow diagram of a method 500 for selecting a receiver configuration according to one embodiment of the disclosure. Method 500 may be used to compare the performance of two or more different receiver configurations and select a receiver configuration for implementation. The different receiver configurations may employ different error-correction codes (e.g., low-density parity-check matrices), different interleaving schemes, etc. In at least some embodiments of the disclosure, method 500 is used to compare receivers that implement different low-density parity-check code matrices having the same codeword length.

For a first receiver, the designer selects a receiver configuration (step 502). The performance of the receiver is simulated (step 504) using communications simulator 100 of FIG. 1 or any other alternative embodiment of communications simulator 100. Further, the simulation is performed using the method described above in relation to method 200 of FIG. 2, method 300 of FIG. 3, or any alternative embodiment of methods 200 and 300.

Steps 502 and 504 are repeated for one additional receiver, and may be repeated for even further receivers if desired (step 506). In at least some embodiments of method 500, the number N of bit locations at which the arbitrary noise will be added is the same for all receivers simulated. Once the performance of each receiver has been simulated, the performances of the receivers are compared (step 508) by, for example, comparing the sector failure rates of the receivers at different signal-to-noise ratio values. The comparison performed in step 508 may be performed by the designer or may be implemented by a computer.

Once the performances of the receivers are compared, the designer selects a receiver configuration for implementation (step 510). In some embodiments of the disclosure, the designer selects the receiver configuration based only on the relative performance of the receivers such that the receiver having the best performance is selected. In other embodiments of the disclosure, the designer selects the receiver configuration based on the relative performances of the receivers and other factors such as implementation complexity. After a receiver configuration is selected, the receiver is implemented in hardware (step 512).

Although communications simulators of the disclosure have been described as simulating the performance of receivers in storage devices, embodiments of the disclosure are not so limited. According to alternative embodiments, communications simulators of the disclosure may be used to simulate receivers in other applications such as receivers used in wired and/or wireless transmissions, wherein the wire or wireless medium is the communications channel that is simulated.

Further, although simulation methods of the disclosure have been described as selecting a signal-to-noise ratio value and testing all codeword patterns at the signal-to-noise ratio value before selecting another signal-to-noise ratio value, embodiments of the disclosure are not so limited. According to some embodiments, simulation methods of the disclosure may select a codeword pattern, and test the codeword pattern for all of the signal-to-noise ratio values in the range of signal-to-noise ratio values before selecting another codeword pattern for testing. Further, according to other embodiments, simulation methods of the disclosure may select the combinations of signal-to-noise ratio values and codeword patterns in a more-random manner.

Yet further, although the blocks in FIG. 1 were described as processing blocks in software program, embodiments of the disclosure are not so limited. According to alternative embodiments of the disclosure, one or more blocks in FIG. 1 may be implemented as circuit-based processes or even human processes as long as at least one of the blocks is implemented as a processing block in a software program or a circuit-based process.

It will be further understood that various changes in the details, materials, and arrangements of the parts which have been described and illustrated in order to explain the nature of this invention may be made by those skilled in the art without departing from the scope of the invention as expressed in the following claims. For example, the failure rate may be represented using a measure other than sector failure rate, such as bit error rate.

Embodiments of the disclosure may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

Embodiments of the disclosure can be embodied in the form of methods and apparatuses for practicing those methods. Embodiments of the disclosure can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the embodiment. Embodiments of the disclosure can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the embodiment. When implemented on a general-purpose processor, the program code segments combine with the processor to provide a unique device that operates analogously to specific logic circuits.

As used herein, the term “non-transitory media” refers to any suitable processor- or computer-usable storage medium or any processor- or computer-readable storage medium. The processor- or computer-usable, or the processor- or computer-readable storage medium may be, for example, but is not limited to an electronic, magnetic, optical, electromagnetic, infrared, or semiconductor system, apparatus, or device. More specific examples (a non-exhaustive list) of the processor or computer-readable medium includes but is not limited to the following: magnetic tape, a portable computer diskette, a hard disk, a random access memory (RAM), a read-only memory (ROM), an erasable programmable read-only memory (EPROM), Flash memory, a portable compact disc read-only memory (CD-ROM), an optical storage device, and a magnetic storage device. Note that the processor-or computer-usable storage medium, or the processor- or computer-readable storage medium could even be paper or another suitable medium upon which the program is printed, as the program can be electronically captured, via, for instance, optical scanning of the paper or other medium, then compiled, interpreted, or otherwise processed in a suitable manner including but not limited to optical character recognition, if necessary, and then stored in a processor or computer memory. In the context of this disclosure, a processor- or computer-usable storage medium, or a processor- or computer-readable storage medium may be any medium that can contain or store a program for use by or in connection with an instruction execution system, apparatus, or device.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the disclosure.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A communications simulator comprising:
a codeword generator adapted to generate an error-correction encoded codeword;
an arbitrary-noise generator adapted to generate an arbitrary-noise signal;
a channel simulator adapted to modify the error-correction encoded codeword based on simulated characteristics of a communications channel and the arbitrary-noise signal to generate a noisy error-correction encoded codeword; and
an error-correction decoder simulator adapted to simulate decoding of the noisy error-correction encoded codeword to attempt to recover the error-correction encoded codeword.

2. The communications simulator of claim 1, wherein:
the communications channel is in a data storage device; and
the simulated characteristics of the communication channel include write noise, read noise, and inter-symbol interference.

3. The communications simulator of claim 2, wherein the channel simulator is adapted to modify the error-correction encoded codeword based on the arbitrary-noise signal before modifying the error-correction encoded codeword based on the inter-symbol interference.

4. The communications simulator of claim 2, wherein the channel simulator is adapted to modify the error-correction encoded codeword based on the arbitrary-noise signal after modifying the error-correction encoded codeword based on the inter-symbol interference.

5. The communications simulator of claim 1, further comprising an error counter, wherein the communications simulator increments the error counter if the decoder simulator does not successfully recover the error-correction encoded codeword.

6. The communications simulator of claim 1, wherein:
the codeword generator is adapted to generate a plurality of error-correction encoded codewords;
for each error-correction encoded codeword, the arbitrary-noise generator is adapted to generate an arbitrary-noise signal;
for each error-correction encoded codeword, the channel simulator is adapted to modify the error-correction encoded codeword based on simulated characteristics of a communications channel and the arbitrary-noise signal to generate a noisy error-correction encoded codeword; and
for each error-correction encoded codeword, the decoder simulator is adapted to simulate decoding of the noisy error-correction encoded codeword to attempt to recover the error-correction encoded codeword.

7. The communications simulator of claim 6, wherein:
for each error-correction encoded codeword, the arbitrary-noise generator is adapted to generate an arbitrary-noise signal for each of a plurality of different signal-to-noise ratio values;
for each combination of an error-correction encoded codeword and a signal-to-noise ratio value, the channel simulator is adapted to modify the error-correction encoded codeword based on simulated characteristics of a communications channel and the arbitrary-noise signal to generate a noisy error-correction encoded codeword; and
for each combination of an error-correction encoded codeword and a signal-to-noise ratio value, the decoder simulator is adapted to simulate decoding of the noisy error-correction encoded codeword to attempt to recover the error-correction encoded codeword.

8. The communications simulator of claim 6, wherein:
each error-correction encoded codeword is a vector; and
for at least two error-correction encoded codewords, the channel simulator is adapted to modify the error-correction encoded codewords to apply arbitrary noise to N elements of the error-correction encoded codeword, wherein N>0.

9. The communications simulator of claim 1, wherein:
for a plurality of signal-to-noise ratio values, the channel simulator is adapted to modify the error-correction encoded codeword to generate a plurality of noisy error-correction encoded codewords;
the decoder simulator is adapted to simulate decoding of the plurality of noisy error-correction encoded codewords;
the communications simulator further comprises a corresponding error counter for each signal-to-noise ratio value; and
for each signal-to-noise ratio value, the communications simulator increments the corresponding error counter if the decoder simulator does not successfully recover the error-correction encoded codeword.

10. A processor-implemented method for simulating performance of an error-correction decoder, the method comprising:
(a) generating an error-correction encoded codeword;
(b) generating an arbitrary-noise signal;
(c) modifying the error-correction encoded codeword based on simulated characteristics of a communications channel and the arbitrary-noise signal to generate a noisy error-correction encoded codeword; and
(d) simulating decoding of the noisy error-correction encoded codeword to attempt to recover the error-correction encoded codeword.

11. The method of claim 10, wherein:
the communications channel is a communications channel in a data storage device; and
the simulated characteristics of the communication channel include write noise, read noise, and inter-symbol interference

12. The method of claim 11, wherein step (c) comprises modifying the error-correction encoded codeword based on the arbitrary-noise signal before modifying the error-correction encoded codeword based on the inter-symbol interference.

13. The method of claim 11, wherein step (c) comprises modifying the error-correction encoded codeword based on the arbitrary-noise signal after modifying the error-correction encoded codeword based on the inter-symbol interference.

14. The method of claim 10, further comprising (e) incrementing an error counter if the decoder simulator does not successfully recover the error-correction encoded codeword.

15. The method of claim 10, wherein steps (a)-(d) are performed for a plurality of error-correction encoded codewords.

16. The method of claim 15, wherein:
each error-correction encoded codeword is a vector; and
for at least two error-correction encoded codewords, step (c) comprises modifying the error-correction encoded codeword based on the arbitrary-noise signal to apply arbitrary noise to N elements of the error-correction encoded codeword, wherein N>0.

17. The method of claim 15, wherein:
for each error-correction encoded codeword, step (c) is performed for a plurality of signal-to-noise ratio values; and
for each signal-to-noise ratio value, an error counter corresponding to the signal-to-noise ratio value is incremented if the decoder simulator does not successfully recover the error-correction encoded codeword.

18. The method of claim 10, wherein:
step (c) is performed for a plurality of signal-to-noise ratio values to modify the error-correction encoded codeword to generate a plurality of noisy error-correction encoded codewords;
step (d) is performed to simulate decoding of the plurality of noisy error-correction encoded codewords; and
the method further comprises, for each signal-to-noise ratio value, incrementing an error counter corresponding to the signal-to-noise ratio value if the decoder simulator does not successfully recover the error-correction encoded codeword.

19. The method of claim 10, wherein the method comprises:
(e) repeating steps (a)-(d) to simulate performance of a second error-correction decoder;
(f) comparing performances of the error-correction decoder and the second error-correction decoder; and
(g) selecting one of the error-correction decoder and the second error-correction decoder based on the comparison of step (f).

20. The method of claim 19, wherein step (f) comprises comparing error rates of the error-correction decoder and the second error-correction decoder.

21. A non-transitory computer-readable storage medium comprising instructions for simulating performance of an error-correction decoder, wherein, when the instructions are executed by a machine, machine performs a method comprising:
(a) generating an error-correction encoded codeword;
(b) generating an arbitrary-noise signal;
(c) modifying the error-correction encoded codeword based on simulated characteristics of a communications channel and the arbitrary-noise signal to generate a noisy error-correction encoded codeword; and
(d) simulating decoding of the noisy error-correction encoded codeword to attempt to recover the error-correction encoded codeword.

22. The non-transitory computer-readable storage medium of claim 21, wherein:
the communications channel is a communications channel in a data storage device; and
the simulated characteristics of the communication channel include write noise, read noise, and inter-symbol interference

23. The non-transitory computer-readable storage medium of claim 22, wherein step (c) comprises modifying the error-correction encoded codeword based on the arbitrary-noise signal before modifying the error-correction encoded codeword based on the inter-symbol interference.

24. The non-transitory computer-readable storage medium of claim 22, wherein step (c) comprises modifying the error-correction encoded codeword based on the arbitrary-noise signal after modifying the error-correction encoded codeword based on the inter-symbol interference.

25. The non-transitory computer-readable storage medium of claim 21, wherein the method comprises:
(e) repeating steps (a)-(d) to simulate performance of a second error-correction decoder;
(f) comparing performances of the error-correction decoder and the second error-correction decoder; and
(g) selecting one of the error-correction decoder and the second error-correction decoder based on the comparison of step (f).
